(19) United States
(12) Patent Application Publication
(10) Pub. No.: US 2025/0306966 A1
(43) Pub. Date: Oct. 2, 2025

(54) PLATFORM FOR A.I. ASSISTANTS DRIVEN KNOWLEDGE FORUM

(71) Applicant: Aparajithan Rajendran, Redondo Beach, CA (US)

(72) Inventor: Aparajithan Rajendran, Redondo Beach, CA (US)

(21) Appl. No.: 19/094,819

(22) Filed: Mar. 29, 2025

Related U.S. Application Data
(60) Provisional application No. 63/572,279, filed on Mar. 31, 2024.

(51) Int. Cl. G06F 9/451; G06F 16/2452; G06Q 30/0601

(52) U.S. Cl. CPC G06F 9/453; G06F 16/24522; G06Q 30/0605

(57) ABSTRACT

The present disclosure relates to a system for dynamic knowledge processing and resource management and a context driven A.I. assistant platform in a marketplace. Various subsystems such as, an input subsystem, virtual assistant subsystems, a plurality of input translator subsystems, and a consumable management assistant subsystem including a consumable catalog and a consumable provider are disclosed. Upon checking that a response to a query requires external knowledge, the query is sent to the consumable management assistant subsystem, where it is detected whether the response to the query is available in the consumable catalog. Accordingly, the response to the query is provided by the consumable provider through triggering a demand-supply-value (DSV) engine, thereby enabling the A.I. assistants to scale their knowledge and serviceability with minimal reprogramming and cost. In addition, the context driven platform offers a real time knowledge driven collaboration forum by tracking storing, publishing real time values of assets.

### FIELD OF THE INVENTION

Embodiments of the present invention relate to the field of artificial intelligence (A.I.) powered assistants, in general and specifically relates to dynamic knowledge processing and resource management and a context specific forum in an A.I. virtual assistant driven marketplace.

### DESCRIPTION OF THE RELATED ART

In recent years, the advent of A.I. powered virtual assistants has transformed the way individuals interact with technology, offering personalized assistance and facilitating various tasks seamlessly. However, despite their remarkable capabilities, the field of A.I. powered virtual assistants faces several challenges that hinder their widespread adoption and effectiveness.

In the world of personal finance and investment, one can find several solutions & mobile applications in the marketplace that can assist in educating users on savings, taxes, investments, stocks, cryptocurrency, precious metal prices, and performance, etc. However, the extent of availability of knowledge, for example, analyzing upcoming trends of stocks, in a niche domain is limited. Other niche domains or markets where there could be a demand for finding trends, preferences, and sentiment analysis, and forecasts in order to adapt knowledge sharing strategies and may be finding better market progressions could range from real estate, genetic testing, and medical tourism, etc.

With the advancement in artificial intelligence, A.I. virtual assistants have become essential companions in our day to day lives, changing how we interact with technology in numerous ways. These intelligent virtual helpers understand and respond to user commands varying from playing music to giving recommendations, thereby allowing a user to perform tasks through different modalities like voice and text.

Machine learning (ML) and natural language processing (NLP) algorithms empowered these assistants to understand context, nuances in human language, and making interactions more seamless and human-like. As A.I. technology continued to improve, the A.I. virtual assistants, herein after referred to as A. I. assistants, became more efficient, accurate, personalized, and capable of learning from user interactions.

Through ML and NLP, A.I. assistants can comprehend complex sentence structures, dialects, and even emotional cues in conversations, and thus can continually adapt, improve based on user feedback making them more effective at fulfilling user needs over time. This adaptability allows them to stay relevant and responsive to changing user preferences.

One of the prominent issues that revolves around the utilization of A.I. assistants is privacy concern. In order to harness specific insights and provide tailored recommendations, A.I. assistants often require access to sensitive user data, including health and financial information. However, the necessity to share such private data raises concerns regarding data security and user privacy. The users are generally hesitant to divulge personal information, fearing potential breaches or misuse of their data by third parties.

Also, the A.I. assistants rely heavily on historical data to enhance their performance and deliver accurate responses. However, the conventional approach of sharing entire datasets with the A.I. assistants result in the accumulation of vast amounts of data, necessitating larger contextual memory for storage and processing. For example, if a user wants to receive some financial advice based on his personal expenditures considering financial data of a span of, for example, last 2 years, 5 years, or 10 years, in present A.I. assistant systems such details of the financial data are shared across third party A.I. databases and then may be pulled before generating responses. This leads to escalated operational costs associated with A.I. infrastructure and maintenance, posing a significant financial burden for businesses and developers.

In addition, the static nature of A.I. assistants present another challenge. Traditional A.I. assistants are often constrained by pre-trained skills and thus lack the flexibility to acquire new knowledge or expand their capabilities autonomously. In scenarios where an A.I. assistant encounters a request beyond their pre-defined skill set, the A.I. assistants face limitations in fulfilling user requirements without undergoing extensive retraining. Such a rigidity impedes the adaptability and versatility of A.I. assistants, limiting their overall utility and ability to cater to the diverse needs of the users effectively.

Finally, the niche areas which require specific knowledge, such as financial securities are time sensitive and require a lot of learning, even formal education at times, many years of real-life experience to interpret and determine the next best action. Obtaining such knowledge or service has always been expensive and not affordable for common people in a timely manner due to the privatization of the financial knowledge and education. This demands democratization of financial knowledge and insights by making them available and affordable for everyone in time. This leads to the need for a time-sensitive knowledge driven collaboration system.

These challenges collectively underscore the pressing need for innovative solutions that address the privacy concerns associated with data sharing, optimize resource utilization to mitigate operational costs, and empower A.I. assistants with the capability to dynamically acquire new skills and knowledge while providing forums for the users to collaborate on the time-sensitive knowledge. By overcoming these impediments, the field of A.I. powered virtual assistants can unlock its full potential, offering enhanced user experiences and revolutionizing human-machine and human-human interactions through knowledge sharing and shopping services in a marketplace setting.

### SUMMARY OF THE INVENTION

Embodiments of the present invention may relate to a system for dynamic knowledge processing and resource management. The system may include an input subsystem to receive an input and a plurality of virtual assistant subsystems communicatively coupled to the input subsystem. In addition, the plurality of virtual assistant subsystems may include a plurality of input translator subsystems to translate the input into a query and a consumable management assistant subsystem which includes a consumable catalog and a consumable provider. Herein, the plurality of input translator subsystems and the consumable management assistant subsystem may be communicatively coupled to the plurality of virtual assistant subsystems. Further, a virtual assistant subsystem, from the plurality of virtual assistant subsystems, may upon checking that a response to the query requires external knowledge, send the query to the consumable management assistant subsystem. The consumable management assistant subsystem may then detect whether the response to the query is available in the consumable catalog. Based on the query and available consumables in the consumable catalog, the virtual assistant subsystem may render the response to the query by the consumable provider. Finally, the virtual assistant subsystem, from the plurality of virtual assistant subsystems, may generate an output from the rendered response. Instead of sharing entire datasets with A.I. assistants, the disclosed invention employs a plurality of virtual assistants, each tasked with specific responsibilities. By distributing the workload among the A.I. assistants, insights can be retrieved without compromising user privacy or sharing extensive personally identifiable information (PII) data sets with the A.I. assistants.

In accordance with an embodiment of the present invention input subsystem may be configured to route the input to one or more virtual assistant subsystems of the plurality of virtual assistant subsystems based on context and intent of a user. By routing to the one or more virtual assistant subsystems of the plurality of virtual assistant subsystems based on the context and intent of the user, an appropriate A.I. assistant may be chosen which may be referred to as an intended A.I. assistant, and may increase the speed of rendering the response.

In accordance with an embodiment of the present invention the input subsystem may comprise an input handler to receive the input from the user in one or more formats of media provided by an electronic device. Further, the input subsystem may apply transformations to the input so as to make input data favorable for downstream transmission. Herein, the at least one of the formats may comprise text, audio, and video. Thus, it is possible to integrate and process multiple types of data, viz., text, audio, and video, referred to as modalities.

In accordance with an embodiment of the present invention each virtual assistant subsystem of the plurality of the virtual assistant subsystems may comprise a user engine connected to a parallel processor and a serial processor. The user engine may be configured to infer the input received from the input subsystem, trigger parallel execution of multiple threads based on the inferred input to generate a merged response, by means of the parallel processor. Further, the user engine may also be configured to sequentially process, by means of the serial processor, the merged response received from the parallel processor. The user engine may act as an inference system integrated with the intended A.I. assistant for the received input. With the help of the dedicated user engine, to execute parallel and sequential processing, the overall inference process may get speed up.

In accordance with an embodiment of the present invention, an input translator subsystem of the plurality of input translator subsystems may convert the query in a SQL query with appropriate variables pertaining to the input and generate key values for variables. By sharing only the query, i.e., SQL query with appropriate variables pertaining to the input, and not specific financial details of the user, privacy concerns regarding sharing sensitive user data with A.I. models are mitigated.

In accordance with an embodiment of the present invention upon checking that the response to the query requires external knowledge, the virtual assistant subsystem comprising the user engine may translate the query into a consumable-demand-request and may send the consumable-demand-request to a consumable requestor, which is an entity in the consumable management assistant subsystem. Further, the consumable requestor may transform the consumable-demand-request and check whether a requested consumable associated with the consumable-demand-request is available in the consumable catalog.

In accordance with an embodiment of the present invention based on the transformed consumable-demand-request and available consumables in the consumable catalog, the consumable catalog may dynamically trigger a demand request to a demand-supply-value (DSV) engine for the requested consumable. The DSV engine may correspond to an algorithm which dynamically determines demand-supply-values of services which are in high demand and further promote such high demand services more among users, of the services, to boost business growth. The DSV engine dynamically matches user demands with available consumables, thereby fostering a collaborative ecosystem of service providers and consumers.

In accordance with an embodiment of the present invention the system may include (i) a consumable demand publisher which publishes the consumable-demand-request, and (ii) a consumable demand viewer in order to develop a requested consumable based on the published consumable-demand-request. By publishing the consumable-demand-request, a developer can then develop an A.I. agent to meet the raised demand and then publish the A.I. agent. The A.I. agent may be defined as an autonomous system that perceives its environment, makes use of available tools, takes decisions, and design workflows, to perform a task. The A.I. agent often use multiple A.I. models to analyze data, solve complex problems, support decision making, and manage complex processes, and generally operate with limited human assistance except in some critical applications. Thus, next time when the same demand comes up, it may be routed to the new A.I. agent.

In accordance with an embodiment of the present invention each virtual assistant subsystems of the plurality of virtual assistant subsystems may comprise a reward distribution subsystem. The reward distribution system may estimate and distribute rewards to a consumable user and the consumable provider, based on evaluation of the response rendered by the consumable provider. The reward estimation and distribution system may assist in training of the system by providing valuable feedback.

In accordance with an embodiment of the present invention, the plurality of virtual assistant subsystems may communicatively connect to a data management subsystem comprising at least: i) a rules repository, ii) a configuration data repository, iii) a user data store, and iv) the consumable catalog.

In accordance with an embodiment of the present invention the function of the consumable catalog may be to inventory consumable resources which are already deployed and are ready to be delivered back to a user as a response to the query. Thus, the consumable catalog serves as a database for the training and inference data.

In accordance with an embodiment of the present invention, the consumable catalog may comprise consumable resources from at least one of a training and an inference dataset.

In accordance with an embodiment of the present invention, to generate the output from the rendered response, the system may include an output handler, communicatively coupled to the plurality of virtual assistant subsystems, to transform and deliver response to a user via output devices. Thus, it is possible to integrate and process multiple types of data, viz., text, audio, and video, referred to as modalities, thereby improving system's overall performance.

In accordance with an embodiment of the present invention, the consumable provider may be one of an external service provider which supplies real time values of assets pertaining to one of the query, an entity relating to the query, and a user in the consumable management assistant subsystem.

Another embodiment of the present invention relates to a system for operating a context specific forum in an A.I. virtual assistant driven marketplace. The system may include a plurality of asset trackers. The plurality of asset trackers may include a datastore to store and manage all available assets of interest from a plurality of forums, a data processor, a plurality of insight generators, a plurality of insight publishers, and a forum manager. The data processor may retrieve real time data values of assets from internal and external service providers and update the datastore with the retrieved data values of assets and transfer past data to a repository. The plurality of insight generators may read the retrieved data values of assets and generate processed data. Further, the plurality of insight publishers may read the processed data and based on the processed data, publish progress of values of assets of interest to all user devices which are currently being watched or monitored by forum users. Lastly, the forum may include a plurality of both asset mappings and A.I. mappings. The forum manager may create, read, update, or delete all data related to the context specific forum. Also, the forum manager may manage mapping of assets associated with each forum of the plurality of forums, mapping of A.I. virtual assistants assigned to each forum of the plurality of forums, and history of questions and answers exchanged on the plurality of forums. Herein, each of the asset mappings may represent assignment of one or more assets in each forum of the plurality of forums and the each of A.I. mappings may represent assignment of one or A.I. virtual assistants to each forum of the plurality of forums. The disclosed system ensures that real time data, i.e., progress of values of assets of interest, is made available to the forum users. Meanwhile, the real time data also gets stored in the datastore for future reference. The disclosed system enables tracking, via the asset tracker, real time values of high demand assets, concurrently updating the same in the database, and making the real time values available to the forum users via one or more different mechanisms.

In accordance with an embodiment of the present invention real time knowledge may be stored in one or more formats, wherein the one or more formats include at least one of text, image, audio, and video, etc. Thus, it is possible to integrate and process multiple types of different modalities. This integration of different modalities allows for a more holistic understanding of complex data, thereby improving system's performance in tasks like visual question answering, text-to-image generation, cross-modal retrieval, image captioning, and aesthetic ranking.

In accordance with an embodiment of the present invention all forum related data may be provided by client applications on devices via a secure application programming interface.

Another embodiment of the present invention may relate to a method for dynamic knowledge processing and resource management. The method may be implemented by the input subsystem and the virtual assistant subsystem of the plurality of the virtual assistants communicatively coupled to the input subsystem, the plurality of input translator subsystems, and the consumable management assistant subsystem. The plurality of input translator subsystems and the consumable management assistant subsystem may be communicatively coupled to the plurality of the virtual assistants. The method may include receiving the input, by the input subsystem. Further, the input may be translated into the query, by the input translator subsystem of the plurality of input translator subsystems. Upon checking, by the virtual subsystem of the plurality of virtual subsystems, that the response to the query requires external knowledge, the query may be sent to the consumable management assistant which may include the consumable catalog and the consumable provider. Further, it may be detected whether the response to the query is available in the consumable catalog. Based on the query and available consumables in the consumable catalog, the response may be rendered to the query by the consumable provider. Finally, the output may be generated from the rendered response. The disclosed method enables A.I. assistants to access external resources beyond their pre-trained skill sets, thereby enhancing their capability to fulfill diverse user requests.

In accordance with an embodiment of the present invention the method may include selecting a virtual assistant from a plurality of the virtual assistants, based on context and intent of the input. Thus, the process of selecting a virtual assistant from the plurality of virtual assistants, by the user, may be avoided and one of the most efficient A.I. assistant, which could assist in answering the query, may get selected during the implementation of the method.

In accordance with an embodiment of the present invention the virtual assistant from the plurality of the virtual assistants may include one or more user engines connected to the parallel processor and the serial processor. The method may include detecting whether the input is for training or inference. Upon detecting an inference input, the method may include generating the request based on the inference input. Further, the method may include triggering parallel execution of multiple threads based on the inferred input to generate the merged response, by the parallel processor and sequentially processing, by the serial processor, the merged response received from the parallel processor. The user engine may act as the inference system integrated with the intended A.I. assistant for the received input. With the help of the dedicated user engine, to execute parallel and sequential processing, the overall inference process gets speed up.

In accordance with an embodiment of the present invention upon checking that the response to the query requires external knowledge, the method may include translating the query into the consumable-demand-request and sending the consumable-demand-request to the consumable requestor, which is the entity in the consumable integration subsystem. The consumable requestor may be used for transforming the consumable-demand-request and checking whether the requested consumable is available in the consumable catalog.

In accordance with an embodiment of the present invention the method may include dynamically triggering the demand request for the requested consumable, to the demand supply value (DSV) engine, based on the transformed consumable-demand-request and available consumables in the consumable catalog. The demand-supply-value (DSV) engine, may dynamically match end-user needs with partner consumables, encompasses various digital services. By boosting demand or supply as needed, the DSV engine ensures optimal resource allocation and fosters business growth while maintaining an optimal demand-supply-value equilibrium.

In accordance with an embodiment of the present invention, the method includes publishing the consumable-demand-request to consumable demand viewers and developing the requested consumable based on the published consumable-demand-request. By publishing the consumable-demand-request, the developer may then develop the A.I. agent to meet the raised demand and then publish the A.I. agent. Thus, next time when the same demand comes it may be routed to the new A.I. agent.

In accordance with an embodiment of the present invention the method may include publishing the A.I. agent as per the consumable-demand-request. Thus, at another instance when the same demand is raised, the query may directly be forwarded to the new A.I. agent thereby resulting in reduced response time for attending the query.

Another embodiment of the present invention may relate to a method for driving the context specific A.I. virtual assistant platform having the asset tracker, the insight generator, and the insight publisher. The method may include receiving and storing real time values of assets, determined by at least one of the A.I. virtual assistant, human, and augmented input of the A.I. virtual assistant and the human. The method may further include generating, by the insight generator, processed data by using the real time values of assets from the asset tracker. Further, the processed data may be availed as insights in one or more consumable formats for client applications.

The insight may then be published, by the insight publisher, on a user device. Thus, the context specific A.I. virtual assistant platform enables users to interact with the A.I. assistants and other expert human users to educate themselves on specific or generic knowledge from the context of the forum that they all have joined. This includes one or more backend systems that generates a time-sensitive knowledge base and manages all the forums related to the knowledge with users' questions and answers which can be used by web services like streams, APIs by applications on any computer and mobile devices.

In accordance with an embodiment of the present invention, the method may include publishing the insight on the user device by either pushing down on the user device on-demand via pull requests or automatically by push requests in real time. Therefore, the published insight can be availed by the user in multiple ways.

Another embodiment of the present invention may include a non-transitory computer readable storage medium having instructions stored thereon, which when executed by one or more processors causes an electronic device to perform a method of receiving an input from a user, translating the input into a query, and upon checking that a response to the query requires external knowledge, sending the query to a consumable integration subsystem which includes the consumable catalog and the consumable provider. Thus, the disclosed system enables A.I. assistants to access external resources beyond their pre-trained skill sets, thereby enhancing their capability to fulfill diverse user requests.

Further, the method may include checking whether the response to the query is available in the consumable catalog. Based on the query and available consumables in the consumable catalog, the method may include rendering the response to the query by the consumable provider and generating the output from the rendered response.

Overall, the disclosed invention enhances the adaptability of A.I. assistants by integrating a marketplace ecosystem. In instances where the A.I. assistant lacks the requisite knowledge or capability, it may seamlessly access external resources beyond its pre-trained set of skills.

The invention could also extend to areas where there is a demand for predictive analytics, research, finding trends, forecasts, and comprehensive insights, among others.

### BRIEF DESCRIPTION OF THE DRAWINGS

So that the manner in which the above-recited features of the present invention is understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

The invention herein will be better understood from the following description with reference to the drawings, in which:

FIG. 1 illustrates a system architecture for dynamic knowledge processing and resource management, in accordance with an embodiment of the present invention;

FIG. 2 illustrates a market ecosystem for dynamic knowledge processing and resource management, in accordance with an embodiment of the present invention;

FIG. 3 illustrates a system architecture for driving a context specific A.I. virtual assistant platform, in accordance with an embodiment of the present invention;

FIG. 4 (a) illustrates a flowchart for the method of dynamic knowledge processing and resource management, in accordance with an embodiment of the present invention;

FIG. 4 (b) illustrates a flowchart for the method of dynamic knowledge processing and resource management, in accordance with an embodiment of the present invention;

FIG. 4 (c) illustrates a flowchart for the method of dynamic knowledge processing and resource management, in accordance with an embodiment of the present invention;

FIG. 5 illustrates a flowchart for the method of driving a context specific forum in an A.I. virtual assistant driven marketplace, in accordance with an embodiment of the present invention;

FIG. 6(a) illustrates a detailed system architecture for dynamic knowledge processing and resource management, in accordance with an embodiment of the present invention;

FIG. 6(b) illustrates a detailed system architecture for dynamic knowledge processing and resource management, in accordance with an embodiment of the present invention;

FIG. 7 illustrates a detailed system architecture for driving a context specific forum in an A.I. virtual assistant driven marketplace, in accordance with an embodiment of the present invention;

FIG. 8(a) illustrates an exemplary graphical user interface (GUI) of an application for driving a context specific forum in an A.I. virtual assistant driven marketplace, in accordance with an embodiment of the present invention; and

FIG. 8 (b) illustrates an exemplary graphical user interface (GUI) of an application for driving a context specific forum in an A.I. virtual assistant driven marketplace, in accordance with an embodiment of the present invention.

It should be noted that the accompanying figure is intended to present illustrations of exemplary embodiments of the present disclosure. This figure is not intended to limit the scope of the present disclosure. It should also be noted that the accompanying figure is not necessarily drawn to scale.

### DETAILED DESCRIPTION OF THE INVENTION

In the following detailed description, numerous specific details are set forth in order to provide a thorough understanding of the embodiment of the invention as illustrative or exemplary embodiments of the invention, specific embodiments in which the invention may be practiced are described in sufficient detail to enable those skilled in the art to practice the disclosed embodiments. However, it will be obvious to a person skilled in the art that the embodiments of the invention may be practiced with or without these specific details. In other instances, well-known methods, procedures and components have not been described in detail so as not to unnecessarily obscure aspects of the embodiments of the invention.

The following detailed description is, therefore, not to be taken in a limiting sense, and the scope of the present invention is defined by the appended claims and equivalents thereof. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. References within the specification to “one embodiment,” “an embodiment,” “embodiments,” or “one or more embodiments” are intended to indicate that a particular feature, structure, or characteristic described in connection with the embodiment is included in at least one embodiment of the present invention.

The terminology employed in the present disclosure is utilized to delineate specific embodiments and does not aim to restrict the scope of the invention. In this context, the term “and/or” encompasses all possible combinations of one or more items listed in association. Further, the terms “a” and “an” herein do not denote a limitation of quantity, but rather denote the presence of at least one of the referenced items.

The conditional language used herein, such as, among others, “can,” “may,” “might,” “may,” “e.g.,” and the like, unless specifically stated otherwise, or otherwise understood within the context as used, is generally intended to convey that certain embodiments include, while other embodiments do not include, certain features, elements and/or steps.

Unless explicitly defined otherwise, all terms, including technical, technological, engineering, and scientific terminology, utilized in this document are presumed to carry the same connotations as commonly understood by individuals possessing ordinary skill in the pertinent field to which this invention pertains. Moreover, it is emphasized that terms, including those cataloged in commonly referenced dictionaries, should be construed to align with their intended meaning within the context of the relevant art and the disclosures provided herein. Any interpretations of terms should refrain from adopting an excessively formal or idealized stance unless explicitly delineated within the present disclosure.

When discussing the invention, it is important to recognize that various techniques and steps are disclosed, each offering distinct advantages and capable of being employed independently or in combination with one another. Therefore, this description avoids redundant enumeration of all possible combinations of individual steps to maintain clarity. However, it should be noted that such combinations are fully encompassed within the scope of the invention and the accompanying claims. Consequently, the specification and claims should be interpreted with the understanding that these combinations are permissible and fall within the ambit of the invention.

When perceiving the arrows between the components, it is understood that the direction of the arrow is only to depict the flow of the request and response highlighting the upstream and downstream systems and it does not restrict or omit the possibility of data that can flow in either direction of the arrow. When there is no arrow connecting any two or more components it only addresses an optimized path flow to achieve the desired goals and meet the needs and it does not restrict or omit the possibility of connectivity required to address any alternate flows the system needs to address for the optimal function.

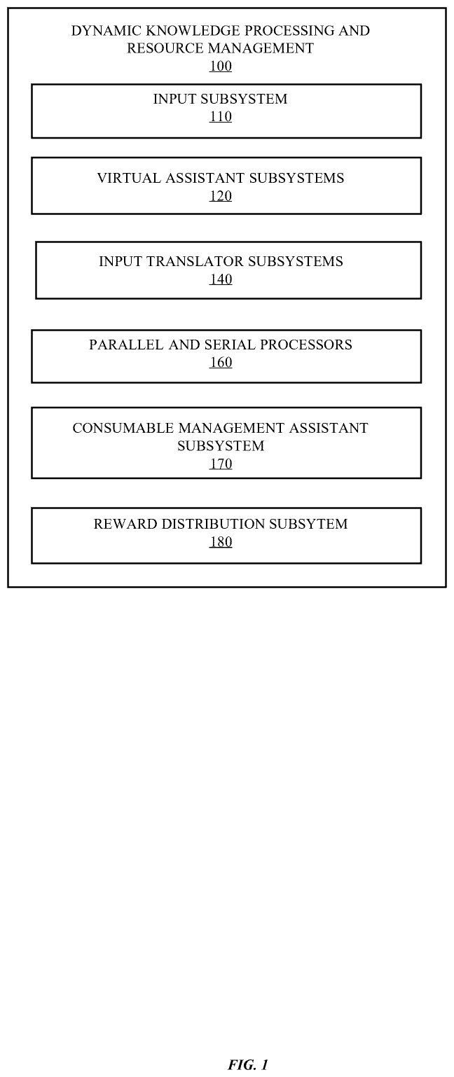

FIG. 1 illustrates a system architecture for dynamic knowledge processing and resource management, in accordance with an embodiment of the present invention. The system 100 may comprise an input subsystem 110, virtual assistant subsystems 120, input translator subsystems 130, parallel and serial processors 140, a consumable management assistant subsystem 150, and a reward distribution subsystem 160. The input subsystem 110 may receive user input in various formats, referred to as modalities, including text, audio, and video, and transmit a received input to an input handler. The integration of multiple types of data formats allows for a more holistic understanding of complex data, thereby improving the dynamic knowledge processing and resource management. An input handler may transform the received input to ensure compatibility with downstream services, for example, considering an e-commerce application with microservices for product catalog, inventory management, order processing, and payment processing, etc., when a user places an order, the order processing microservice is downstream of the inventory management microservice, which is in turn downstream of the product catalog microservice. The input handler could be an application that may receive the input and apply necessary transformation so that the downstream service can process the transformed input.

The virtual assistant subsystems 120 may include multiple entities, such as a user engine, a demand-supply-value engine, a consumable management assistant subsystem 150, and a reward distribution subsystem 160. In an example, the user engine may include an input processing unit capable of handling diverse modes of user inputs, which may be received as input from the input handler. In another example, the user engine may be an inference system which is integrated with an intended A.I. assistant for the received input. The user engine may process input, initiating parallel and sequential processing.

The input translator subsystems 130 are intended to translate an input into a query. The input translator subsystems 130 may include an input-to-SQL formula generator and input-to-key value generator. Further, input translator subsystems 130 may translate the query into a consumable-demand-request and send it to a consumable requestor.

The consumable management assistant subsystem 150 is for sourcing and integrating consumable resources from external providers.

The reward distribution subsystem 160 may estimate and distribute rewards based on user interactions and performance of the consumable provider. The reward distribution subsystem 160 may include a consumable reward estimator and a consumable reward payer. The consumable reward estimator may correspond to one or more A.I. applications that receive a consumable review and calculate rewards based on feedback obtained from the consumable review. The consumable reward estimator may generate a deserving reward for both a consumable user and the consumable provider based on collective reviews, ratings, ranks, and scores from users which may be then passed. If the reward is determined to be paid, then the reward details may be sent to the consumable reward payer.

The consumable reward payer may distribute rewards to providers and users. The consumable reward payer may correspond to an application that credit/debits the rewards based on contractual obligations made between the business and consumable provider. The consumable reward payer may also credit the rewards to the user based on their contractual obligations made with a certain business. The contractual obligations may be determined depending upon the requirement for particular businesses. In an example, for a share market related application, the contractual obligations could provide data with respect to a specific market scenario or of different countries. In another example, for a healthcare related application, the contractual obligations could provide data with respect to a specific lifestyle-related diseases and the database relating to the healthcare application would not share insights about financial dynamics of markets.

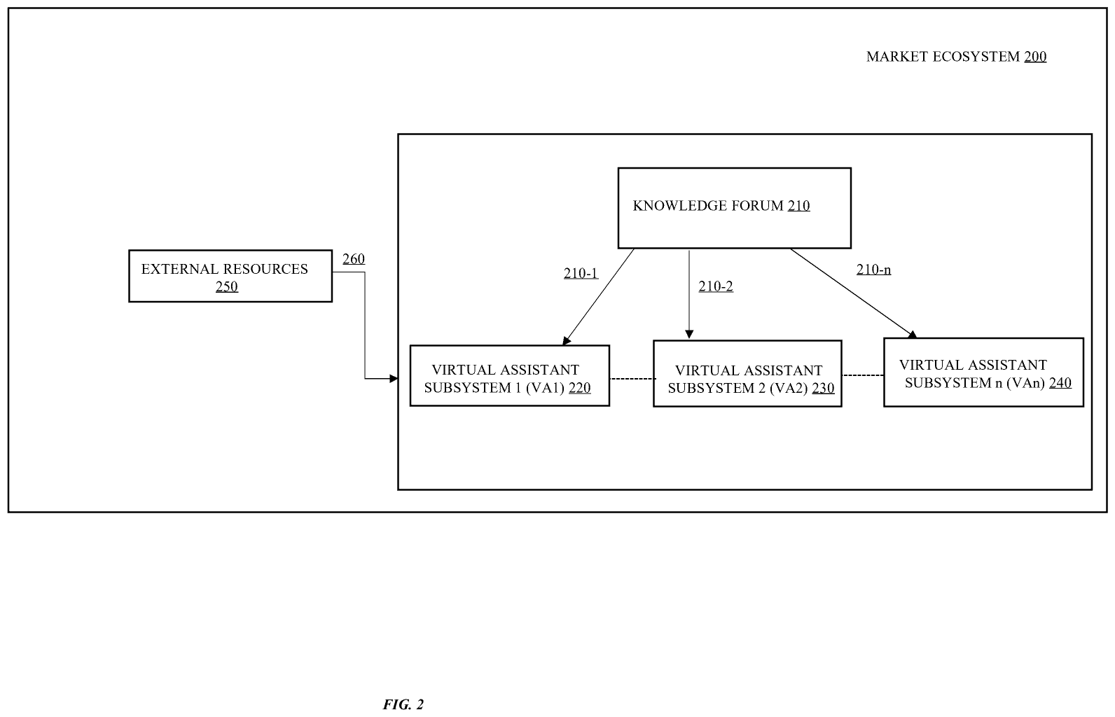

FIG. 2 illustrates a market ecosystem 200 for dynamic knowledge processing and resource management, in accordance with an embodiment of the present invention. The market ecosystem 200 employs a decentralized architecture including a knowledge forum 210 of a plurality of virtual assistant subsystems 220, 230, and 240. The plurality of virtual assistant subsystems 220, 230, and 240 may be communicatively connected to the market ecosystem 200 through a plurality of connections 210-1, 210-2, and 210-n. Thus, depending upon the requirement of data for addressing the query, any number of virtual assistant subsystems could be availed.

The market ecosystem 200 supports a variety of wireless communication standards to ensure seamless integration with the plurality of virtual assistant subsystems. In an example, IEEE 802.11 (Wi-Fi) may enable high-speed data transmission between the virtual assistant subsystems and cloud-based servers for tasks like inventory updates or processing user commands. In another example, Bluetooth/Bluetooth Low Energy (BLE) may facilitate short-range communication between the virtual assistant subsystems and nearby IoT devices. In another example, Zigbee/Z-Wave which is designed for low-power IoT devices within smart retail environments, may enable efficient communication between the virtual assistant subsystems by using sensors and actuators. In another example, 5G cellular networks may provide ultra-low latency connections for mobile virtual assistant subsystems interacting with cloud services or edge computing nodes. The disclosed market ecosystem ensures robust backend connectivity to process data from the virtual assistant subsystems. Thus, with the help of cloud-based servers, large-scale data analytics can be handled using Wi-Fi or 5G connections. Further, edge computing nodes may process time-sensitive tasks locally to reduce latency and improve response times.

In instances, where the A.I. assistant lacks the requisite knowledge or capability, the disclosed system can seamlessly access external resources 250 through an external communication link 260 beyond the pre-trained set of skills of the A.I. assistant. The disclosed knowledge forum 210 offers dynamic knowledge processing and resource management through the integration of the plurality of virtual assistant subsystems 220, 230, 240 and external resources 250 in the market ecosystem 200. The external resources 250 may vary from a particular financial repository of specific funds to databases of financial institutions. Therefore, the availability of knowledge from external resources assists in context-driven collaboration and service adaptability.

In an implementation, application programming interfaces (APIs) enable secure data exchange between the market ecosystem 200 and external resources or third-party services 250 integrated with the plurality of virtual assistant subsystems 220, 230, 240 via a wireless connection 260. In an example, to address privacy concerns and ensure secure communication, all wireless transmissions to enable the wireless connection 260 may be encrypted using advanced algorithms such as, advanced encryption standards (AES) or RSA. The AES encryption algorithm (also known as the Rijndael algorithm) is a symmetric block cipher algorithm with block size of variable key length (for example, 128, 192, and 256 bits). Once the blocks are encrypted, the AES algorithm joins them together to form the ciphertext.

Further, RSA stands for Rivest Shamir Adleman and it is a public-key encryption technique used for secure data transmission especially over the internet. Transmitting confidential and sensitive data over the internet through RSA is safe due to its standard encryption method. Also, using the RSA algorithm, the user devices may be authenticated via secure tokens before accessing the market ecosystem.

The disclosed system employs a decentralized architecture, comprising a network of virtual assistants and the marketplace ecosystem, to enable efficient communication, resource allocation, knowledge driven collaboration, and service expansion.

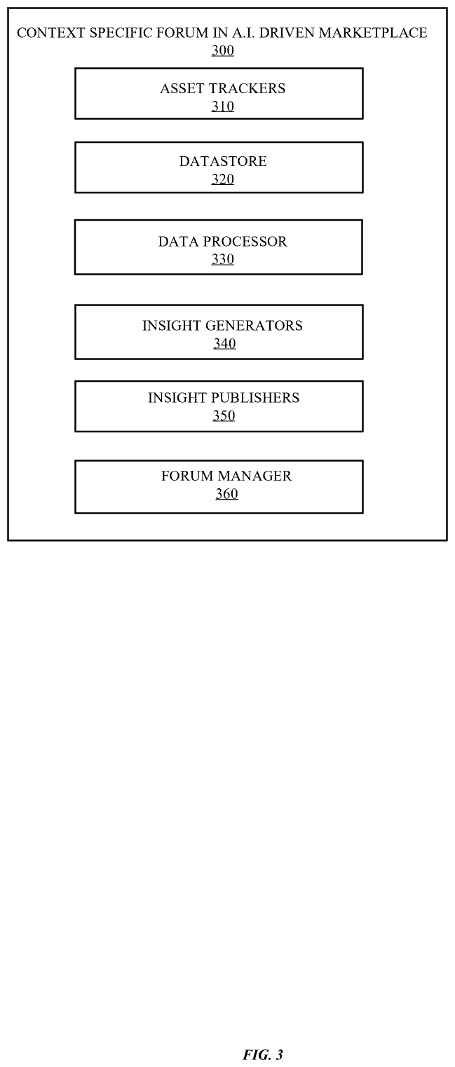

FIG. 3 illustrates a system architecture for driving a context specific A.I. virtual assistant platform, in accordance with an embodiment of the present invention. The context specific A.I. virtual assistant platform hereinafter referred to as the A.I. virtual assistant platform 300 is an interface which offers knowledge driven real-time information, specific to a particular context. In an example, when a user seeks information as to how a particular company's stock price has been affected by a major political activity, the disclosed A.I. virtual assistant platform 300 may provide a real-time analysis. The A.I. virtual assistant platform 300 may comprise asset trackers 310, a datastore 320, a data processor 330, insight generators 340, insight publishers 350, and a forum manager 360.

The asset trackers 310 are dedicated to track real time values of assets. The assets may refer to an any resource, data, component, or entities which are part of a query raised through the input provided by the user.

The datastore 320 stores user information for retrieval and processing. In the data store, the user data may be stored in variety of forms. In an example, the user data may be stored in a structured or unstructured or semi-structured form.

In a preferred embodiment, the data may be stored in the structured form as vector embeddings, to facilitate efficient and accurate data access within the datastore 320. The vector embeddings may serve as compact, high-dimensional numerical representations of data elements, enabling advanced search, retrieval, and analytics functionalities.

For generation of vector embeddings, data items may be stored in the datastore 320, including but not limited to text, images, audio, and structured data, are pre-processed to generate vector embeddings. Each data item is converted into a unique vector representation using a machine learning model, such as a neural network-based embedding generator. For instance, textual data may be transformed using natural language processing (NLP) models, such as word2vec, GloVe, or transformer-based architectures. Images may be encoded using convolutional neural networks (CNNs) to generate feature-rich embeddings. Audio data may be processed through spectrogram analysis and corresponding vector embeddings may be created using audio-specific deep learning models.

Further, the datastore 320 may be configured to store both original data and its corresponding vector embeddings. Each vector embedding is indexed and associated with metadata describing its source data item (e.g., type, timestamp, tags). The embeddings are stored in a high-dimensional vector space within the datastore 320, enabling advanced similarity-based queries.

To retrieve data, a query input (e.g., a text phrase or an image) may be converted into its vector representation using the same embedding generation model. The query vector may then be compared to the stored vector embeddings in the datastore 320 using distance metrics, such as, cosine similarity, euclidean distance, or manhattan distance. Accordingly, items with the closest vector matches to the query vector may be identified as relevant results.

Further, the vector embeddings capture semantic and contextual relationships among data elements. For example, semantically related words (e.g., “car” and “vehicle”) may have closely aligned vector representations. Such semantic understanding and search enables the system to retrieve data that aligns with the intent and context of the query rather than relying solely on exact keyword matches.

The datastore 320 may employ indexing mechanisms, such as approximate nearest neighbor (ANN) search algorithms, to improve speed and scalability of vector comparisons. Examples include hierarchical navigable small world (HNSW) graphs or k-d trees. Such indexing and optimization methodology ensures rapid access to relevant data, even in large-scale systems containing millions of vector embeddings.

The described vector embedding-based datastore can be utilized for various purposes, including recommending similar or related items based on user preferences, locating visually or acoustically similar items in multimedia collections, discovering semantically related concepts in knowledge bases, and accessing contextually relevant data to enhance A.I. conversational agents.

The vector embeddings may be periodically updated to reflect newly added data and evolving contextual relationships. The continuous update and adaptation may involve retraining or fine-tuning the embedding generation models, as needed, to improve retrieval accuracy and relevance.

Further, to ensure data privacy and security, sensitive user data may be anonymized before embedding generation. Encryption protocols may be employed to safeguard both the data and its vector representations during storage and transmission.

In an example, the user data could be stored as graph or hybrid of multiple forms. In another example, the user data may be stored in any other form or format for an efficient retrieval.

The data processor 330 may include custom algorithms, business logic functions and general-purpose processors (GPUs) or microcontroller(s), such as ARM processors, x86 processors, digital signal processors (DSPs) or custom-designed application-specific integrated circuits (ASICs). Particularly, DSPs are designed for real-time signal processing tasks such as audio, video, and telecommunications and used in speech recognition and audio processing software. ASICs may be custom-designed for specific software tasks, such as A.I. model inference and thus may be used in high-efficiency computing for niche applications.

The insight generators 340 are designed to read processed data and generate real time knowledge which can be then stored in one or multiple formats including but not limited to text, image, audio, video, etc.

The insight publishers 350 are designed to read the generated real time knowledge and publish the progress of the values of the interested assets to all the user devices which are currently being watched or monitored by the forum users. The insight publishers 350 may publish the insight on the user device by either pushing down the insight, on the user device, on-demand via pull requests or automatically pushing requests in real time. Thus, any lag in data transmission could be obviated due to absence of fetching of historical records.

The forum manager 360 is designed to create, read, update, delete all the form related data. All the forum related data is provided by client applications on user devices via a secure application programming interface and may be consumed by the client applications on the user devices. The forum manager 360 may comprise a plurality of both asset mappings and A.I. mappings. The asset mappings may represent assignment of one or more assets in the forum and the A.I. mappings may represent assignment of one or more A.I. virtual assistant subsystems to each forum. Thus, the forum manager 360 manages user inquiries & responses from all the users in all the forums along with the mapped assets attached to the forum. In addition, the forum manager 360 also handles all the user requests from the forums on the digital devices.

The A.I. virtual assistant platform 300 may leverage various A.I. generators which are one or more A.I. applications that may use the pre-trained knowledge along with a set of rules or prompts, metadata, master data and any other configuration inputs to generate output values. The master data may be defined as a subset of a pre-defined configuration data necessary for the A.I. virtual assistant platform 300 to transform or generate an appropriate transformation of the natural language queries into SQL queries. The A.I. generators, for example, Open AI agents, Amazon bedrock, Google vertex Al, Microsoft azure cognitive services, and Jupyterlab, etc. might be employed in the disclosed invention. Further, A.I. models used in these A.I. generators may search for and collect data from users and provide the users with additional value from insights that the A.I. generators may obtain by scrutiny. Alternatively, the A.I. virtual assistant platform 300 may develop insights from data patterns that are otherwise imperceptible for humans, owing to streams of big data. By the division of responsibility among various A.I. generators, the A.I. virtual assistant platform 300 can scale the knowledge and serviceability with a minimal reprogramming and retraining efforts thereby offering an ergonomic way of orchestrating the A.I. assistants.

In an embodiment, the A.I. virtual assistant platform 300 may enable users to interact with the plurality of virtual assistant subsystems 220, 230, and 240 and other expert human users to educate themselves on the specific or generic knowledge from the context of the forum that they all joined thereby offering real time knowledge driven collaboration.

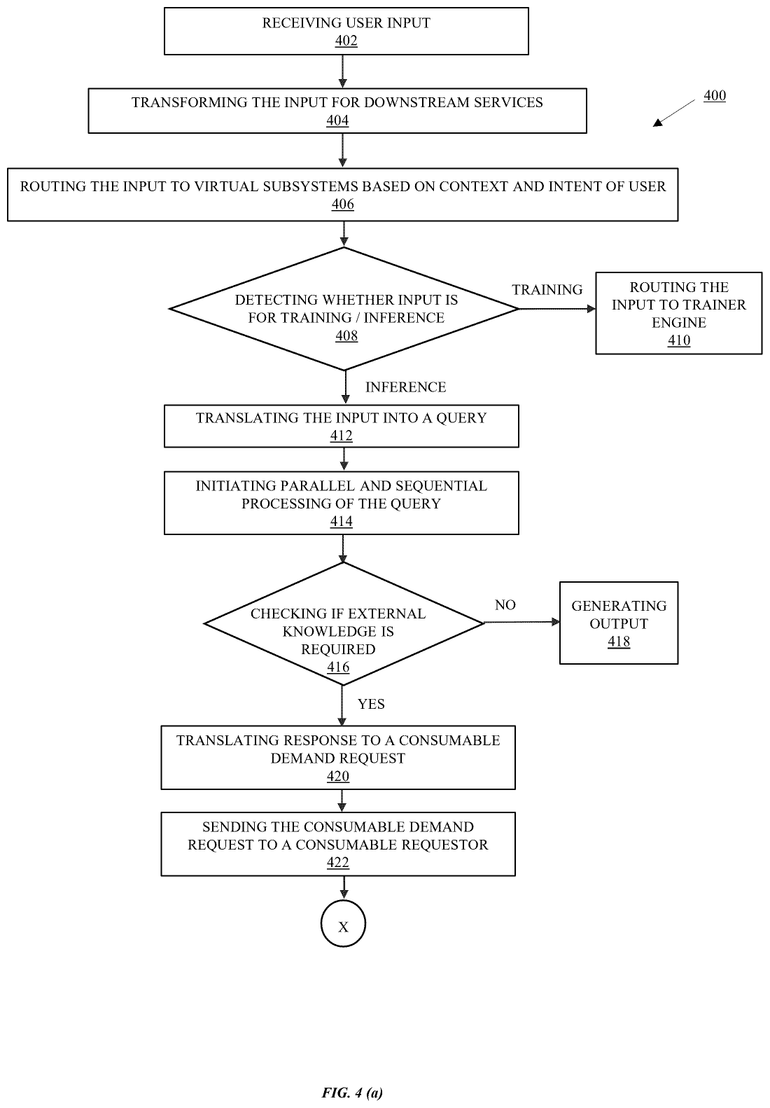

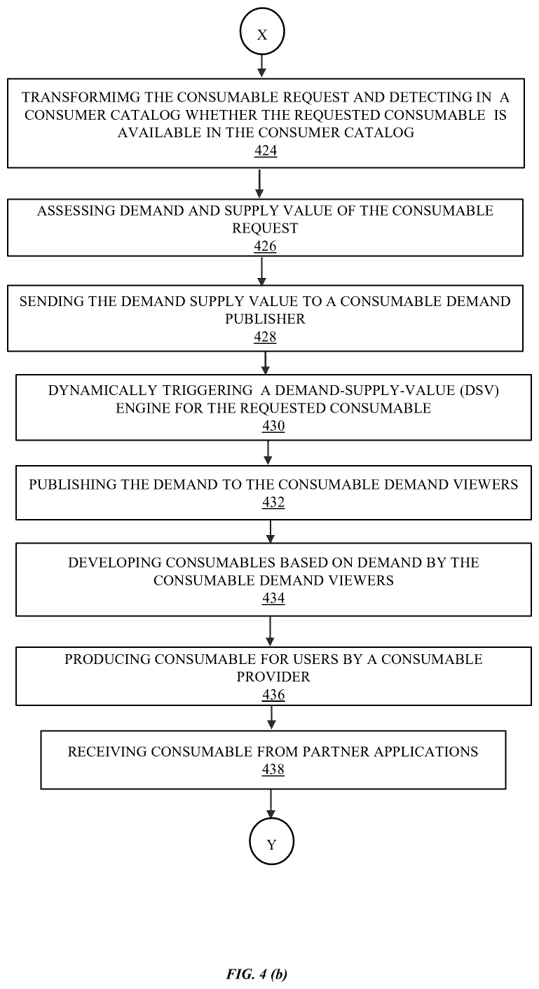

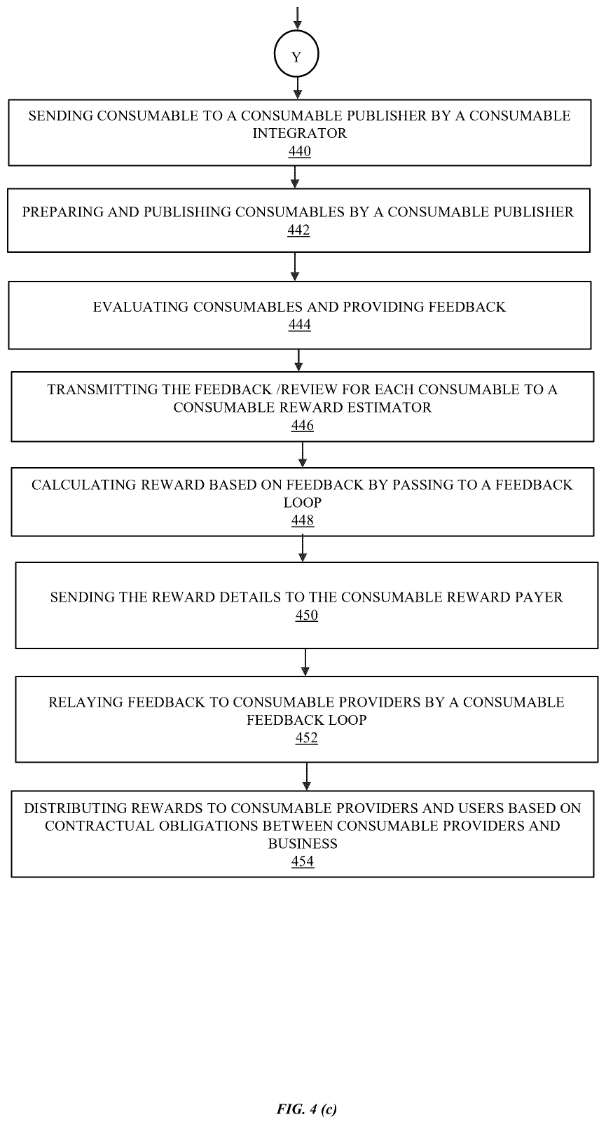

FIG. 4 (a) illustrates a flowchart for the method 400 of dynamic knowledge processing and resource management, in accordance with an embodiment of the present invention. The method begins with receiving a user input 402. The method includes transforming the input for downstream services at 404.

At 406, the method includes routing the input to virtual subsystems based on context and intent of user.

At 408, the method recites detecting whether input is for training or inference. If the input is for training of the A.I. assistant system, then the method includes sending the input to a trainer engine 410. The trainer engine 410 may be used for testing the A.I. assistant system.

The training process may be designed, by third parties, to develop the A.I. assistant's ability to understand, interpret, and respond to user inputs in a conversational manner. The training involves a multi-phase approach comprising at least data acquisition, preprocessing, model training, and validation, as outlined below.

Data collection: The training process begins with the collection of large-scale datasets comprising diverse forms of textual, auditory, and multimodal input. These datasets may include natural language conversations, domain-specific knowledge bases, and user behavior logs. To enhance linguistic diversity, data sources may include multiple languages, cultural contexts, and communication styles.

Data preprocessing: The raw data may be subjected to preprocessing to ensure quality and relevance. The preprocessing includes steps such as noise removal, normalization, tokenization, and annotation. For instance, in the case of textual data, irrelevant content (e.g., misspellings, duplicate entries) may be filtered out, while punctuation and capitalization may be standardized. For audio data, noise suppression and segmentation may be applied.

Model Training: The A.I. assistant may be powered by a machine learning model, such as a neural network-based natural language processing (NLP) model. The training phase may include (a) supervised learning in which annotated datasets with labeled responses may be used to train the A.I. model to map user inputs to appropriate outputs, (b) unsupervised learning in which the model may be exposed to unannotated data to discover patterns and contextual meanings autonomously, and (c) reinforcement learning in which the model may undergo iterative optimization based on feedback mechanisms, where it learns from rewards and penalties to improve its conversational quality.

Contextual Fine-Tuning: To optimize the A.I. assistant for specific use cases, the A.I. model may undergo fine-tuning with specialized datasets. For instance, if the A.I. assistant may be designed for medical support, it may be trained on medical terminologies, protocols, and context-specific scenarios.

Multimodal Training: In addition to textual data, the A.I. assistant may be trained on visual and auditory inputs to interpret images, videos, or spoken language. Advanced techniques, such as audio-text alignment or image-captioning models, may be employed to enable cross-modal understanding.

Personalization Framework: The A.I. assistant may integrate a personalization module that may adapt its responses based on user preferences, history, and contextual cues. Training includes simulating personalized interactions using anonymized user behavior datasets.

Validation and Evaluation: The trained A.I. assistant may undergo rigorous validation to ensure accuracy, relevance, and robustness. Test datasets may comprise edge cases, adversarial inputs, and rare conversational scenarios may be employed. Metrics such as, accuracy, fluency, and user satisfaction scores may be used to evaluate performance.

Continuous Learning: Post-deployment, the A.I. assistant may be equipped with mechanisms for continuous learning. User interactions may be anonymized and analyzed to identify improvement areas, and periodic updates may be applied to the A.I. assistant to refine its capabilities.

Ethical Compliance: Throughout the training process, adherence to ethical A.I. guidelines is maintained. Data privacy measures may be implemented, ensuring user data is anonymized and encrypted. Bias mitigation techniques may also be employed to enhance fairness and inclusivity.

In a preferred embodiment of the disclosed invention, the testing process may include providing rules or A.I. based prompts (hereinafter referred to as prompts) to the A.I. assistant system to address a query. By definition, the prompt is a set of instructions or input provided to an A.I. assistant system to guide its output or behavior. Giving prompts is analogous to having a conversation with an incredibly smart, but sometimes literal-minded, assistant. Thus, one needs to frame the instructions or inputs in a way that the A.I. system can understand and act upon effectively. Prompts come in various forms, each suited to different applications and A.I. models, for example, text-based prompts, image prompts, code prompts (designed for programming tasks and may instruct the A.I. assistant to generate code, debug existing code, or explain programming concepts), and multimodal prompts (such prompts combine different types of input, such as text and images and are used in more advanced A.I. systems that may process and generate multiple types of media). In an example, the prompt may be provided in a particular format, for example, (i) instructions and (ii) query. In an example, the prompt may be provided as statements or questions or commands. For the prompt, a context may be provided first as instructions and then the query. In an example, the prompt may be provided to constraints, for example, restrict word length of an output response to 150 words. For example, the context may be given to the A.I. assistant as ‘draft answers like you are conversing with a teenager’ and the query may be ‘how to start investing in the US share market?’. Once the output response is provided upon prompting (entering the prompt), the output response may be analyzed, improved, and prompting could be repeated again. In order to achieve best results while actually inferencing, extensive training of the A.I. assistant, by way of iteration of the prompting process, is required.

If the input is for inference purpose, then the method proceeds to next step 412 which is translating the input into query.

At 414, the method includes initiating parallel and sequential processing of the query.

At 416, the method includes checking if external knowledge is required for processing the query. If not, an output is generated after processing of the query 418. The output can be in any of the formats, viz., text, images, or video. If yes, the response of the query is translated to a consumable request at step 420.

At 422, the method includes sending the consumable demand request to a consumable requestor.

FIG. 4 (b) illustrates a flowchart for the method of dynamic knowledge processing and resource management, in accordance with an embodiment of the present invention. FIG. 4 (b) is a continuation of the method flowchart depicted in FIG. 4(a).

At 424, the method includes transforming the consumable request by the consumable requestor and detecting in a consumer catalog whether the requested consumable is available in the consumer catalog.

At 426, the method includes assessing demand and supply value of the consumable request.

At 428, the method includes sending the demand supply value to a consumable demand publisher.

At 430, the method includes dynamically triggering a demand-supply-value (DSV) engine for the requested consumable.

At 432, the method includes publishing the demand to the consumable demand viewers.

At 434, the method includes developing consumables based on demand by the consumable demand viewers.

At 436, the method includes producing consumable for users by a consumable provider.

At 438, the method includes receiving consumable from partner applications. The partner application corresponds to external resources for availing the real-time data.

FIG. 4 (c) illustrates a flowchart for the method of dynamic knowledge processing and resource management, in accordance with an embodiment of the present invention. FIG. 4 (c) is a continuation of the method flowchart depicted in FIG. 4(b).

At 440, the method includes sending consumable to a consumable publisher by a consumable integrator.

At 442, the method includes preparing and publishing consumables by a consumable publisher.

At 444, the method includes evaluating consumables and providing feedback.

At 446, the method includes transmitting the feedback/review for each consumable to a consumable reward estimator.

At 448, the method includes calculating reward based on feedback by passing to a feedback loop.

At 450, the method includes sending the reward details to the consumable reward payer.

At 452, the method includes relaying feedback to consumable providers by a consumable feedback loop.

At 454, the method recites distributing rewards to consumable providers and users based on contractual obligations between consumable providers and business.

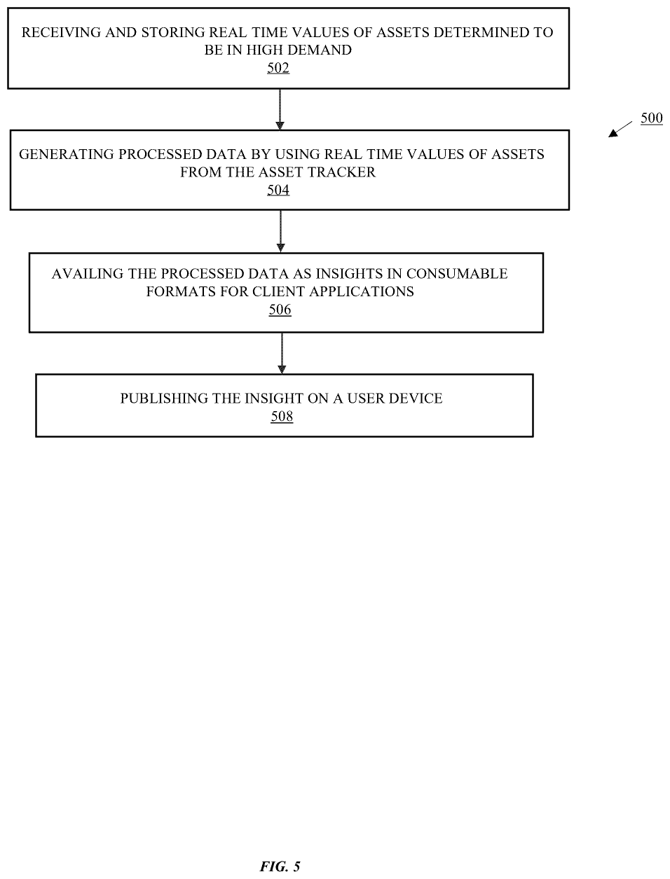

FIG. 5 illustrates a flowchart for the method 500 of driving a context specific forum in an A.I. virtual assistant driven marketplace, in accordance with an embodiment of the present invention.

At 502, the method includes receiving and storing real time values of assets determined to be in high demand.

At 504, the method recites generating processed data by using real time values of assets from the asset tracker.

At 506, the method recites availing the processed data as insights in consumable formats for client applications.

At 508, the method recites publishing the insight on a user device.

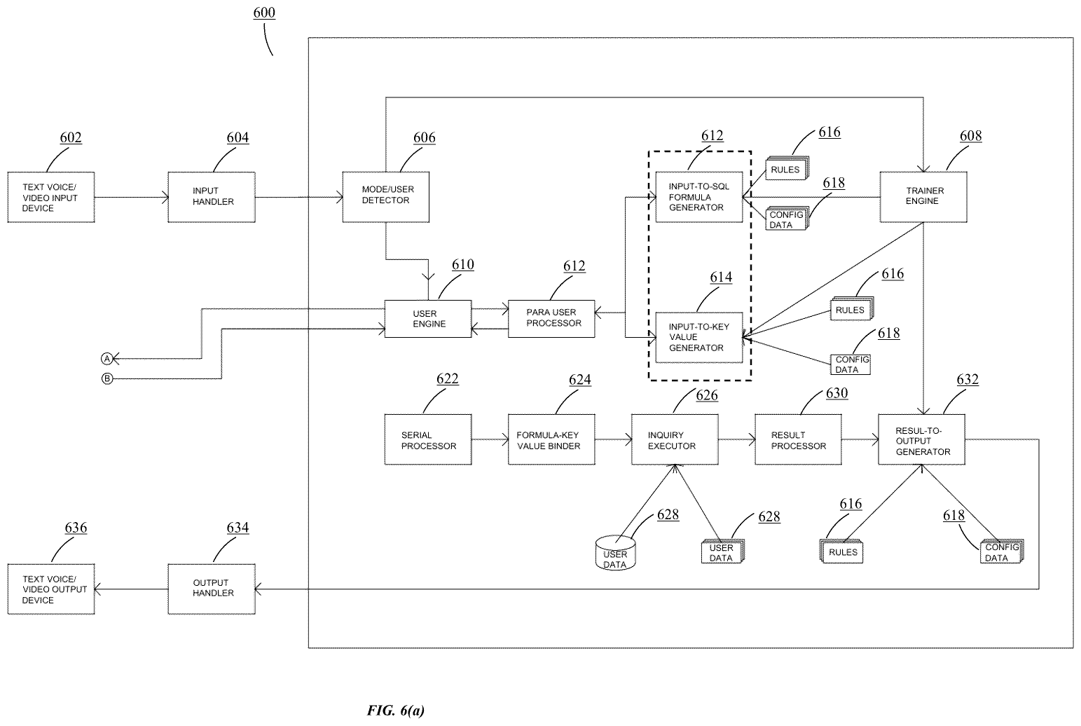

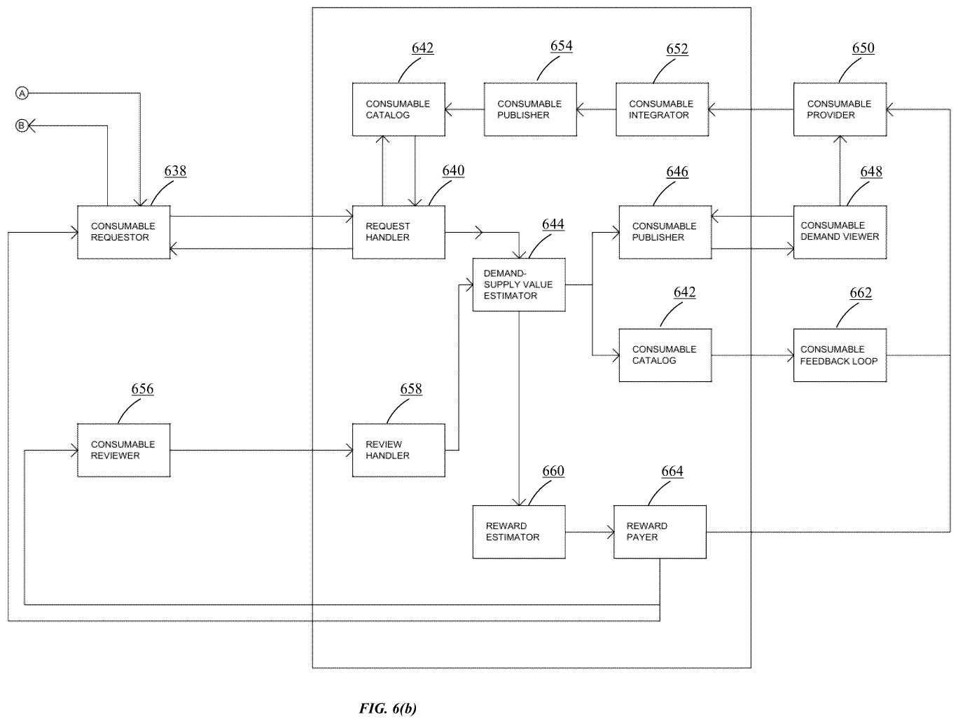

FIG. 6(a) illustrates a detailed system architecture 600 for dynamic knowledge processing and resource management, in accordance with an embodiment of the present invention. The detailed system architecture illustrates a text/voice/video input device 602 which is any physical device that receives user input in one or more forms of text, audio, video, and mixed form. The input from a user may be in form of a natural language (NL) question, also known as utterance. The input device 602 may also be referred to as a user device, for example, a mobile phone, a computer system, or a laptop etc. The input device 602 may have a physical keypad or digital screen, an audio input device, and an image capturing unit to aid in providing an input provided to the system in FIG. 6 (a). Further, the input device 602 provides the input in the one or more forms to an input handler 604. The input handler 604 is an application may receive the input and apply the necessary transformation(s) so the downstream service will be able to process the transformed input. The input handler 604 transforms the received input, from the input device 602, to ensure compatibility with downstream services. The examples of downstream services have been provided earlier in the description of FIG. 1.

Further, the input handler 604 may be connected to a mode/user detector 606. The mode/user detector 606 is an application that may receive the transformed input and detect the conversing user's identity. The mode/user detector 606 may identify an input purpose based on the transformed input received from the input handler 604. Also, the mode/user detector 606 detects whether the input is for training or inference purpose and may apply any other additional logic to make necessary routing.

In case, the input is for training purpose, the input may be sent to a trainer engine 608 which enhances A.I. systems through input-based training with the received input.

In case, the input is for inference purpose, the mode/user detector 606 connects to a user engine 610. The user engine 610 is an inference system integrated with intended A.I. assistant for the received input. Upon receiving the input as an inference request, the user engine 610 calls a parallel processor 612 to trigger multiple threads in parallel and receives responses from all the triggered threads in parallel.

The parallel processor 612 executes multiple threads simultaneously to reduce latency. In an example, the parallel processor 612 may be an application that can run multiple threads of codes in parallel for process latency reduction leading to time-efficient execution. The parallel processor 612 may be communicatively connected to an input-to-SQL formula generators 614 and a plurality of input-to-key value generators 616. When triggered by the user engine 610, the parallel processor 612 may execute two threads of calls, one to the input-to-SQL formula generators 614 and another to the plurality of input-to-key value generators 616. The input-to-SQL formula generators 614 and an input-to-key value generators 616 are part of the input translator subsystems 130.

The input-to-SQL formula generators 614 dynamically create SQL queries. The input-to-SQL formula generator 614 is one or more A.I. applications that may use a pre-trained A.I. based model along with a set of rules 618, instructions, metadata, master data, and any other configuration data or inputs 620 for fine tuning of the A.I. based model. The rules are the instructions or prompts that are used to train the A.I. models. Every A.I. model has its own set of rules applied. Further, the configuration data 620 provides training and inference data for A.I. models. The configuration data 620 is used as a generic term that can represent any data used during training with and/or inference from an A.I. system. The A.I. system may be defined as an A.I. model or A.I. assistant or A.I. agent utilized in the present invention. Every A.I. system has its own set of configuration data 620 for use. The fine-tuned A.I. based model may then be used to dynamically generate SQL query with the appropriate variables. To perform complex NL processing, various ML models may be used, for example, supervised models, unsupervised models, semi-supervised models, and reinforcement learning models. The supervised models use labeled data in which each data instance has a known category or value to which it belongs. This results in the supervised model to discover a relationship between input features and a target outcome. Examples of the supervised models may include support vector machines (SVM), random forest, K-nearest neighbors (KNN), and linear regression, etc. Further, the unsupervised models involve a difficult task of working with data which is not provided with pre-defined categories or label(s) and may be categorized into clustering, dimensionality reduction, and anomaly detection.

DNNs can perform complex computations because they contain many layers of these ML models or ML classifiers. At each layer, the DNN based models may create relationships between their inputs, thus enabling DNNs to extract more complex relationships and produce more sophisticated predictions or outputs. DNNs utilize large amounts of computational power and memory usage during the training and inference processes as the DNNs include millions of computational elements.

Transformer models are the core foundation that enable NL processing and generative A.I. because they learn context and develop meaning by tracking relationships in sequential data like the words in this sentence. Transformer models are a type of DNN that use specialized computation units along with simple neural network computational units. The specialized and simple neural network computation units allow the transformer model(s) to interpret each input element in an appropriate context, so that the transformer model may compute relationships between the input elements. The relationships play a key role in the translation of NL utterance to SQL.

Each input word in the input element is known as an input token, and information is conveyed from one input token to another by means of computation between the input tokens in a matrix of a database schema (the organization and structure of a database including relationships between the entities such as, table, data types, and fields, etc.). For a particular layer of the DNN, relationship values may be stored as vector fields between the input tokens and database schema. For example, if a user wants to get some financial advice based on his personal expenditure then the present invention ensures that the personal expenditure information does not get shared across any third-party public databases, across the A.I. assistants. The A.I. assistants may only store some configuration data, etc. and not the actual financial data. Rather, SQL schema may be employed to store the actual financial data in an encrypted form. The information pertaining to the user may be stored in the hidden layers of the transformer model and the translation between the input or NL utterance to SQL can be obtained without sharing the personal identification information (PII) details of the user across the A.I. model and eliminating any security concerns. In addition, to the above advantage, by obviating storage of any historical data in the any third-party public databases but in a SQL schema, efficiency of the A.I. system may be increased manifold since the query results may be fetched at a high speed.

In addition, while using large language models (LLMs) using which the A.I. models have been developed, a pre-defined number of tokens may be availed. The accuracy of the A.I. models may get effected by training. By using the SQL schema for storing the financial details, a large volume of tokens may be saved. Otherwise, storing the financial details in the third-party public databases may consume a large chunk of available tokens which may then affect the accuracy of the rendered output.

The present invention holds application for those service providers who wants to use third party A.I. virtual assistants or A.I. agents, which employs pre-trained LLM's. In case, the service providers wish to train LLM by themselves and use private agents, although the privacy concerns may be alleviated, however, training the LLM's may consume high number of tokens and may drastically affect the accuracy of the system.

In an embodiment of the disclosed invention, as the input-to-SQL generators 614 convert an unstructured query to a structured form derived from the database schema, hallucinations arising from the output generated by the transformer models may be minimized. Hallucination may be defined as an instance when a transformer model produces irrelevant, inappropriate, or incorrect information.

The input-to-key value generators 616 may identify key values for variables. The input-to-key value generator 616 is one or more A.I. applications that may use a pre-trained A.I. based model along with the set of rules 618, metadata, master data, and any other configuration data or inputs 620 for fine tuning of the A.I. based model. The fine-tuned A.I. based model may then be used to identify the respective key values for the required variables. Since the input-to-SQL formula generators 614 and an input-to-key value generators 616 employs pre-trained and rather fine-tuned A.I. models, the disclosed invention (i) obviates the need for service providers to incur further training of the A.I. based models and thus allows them to directly test the model, and (ii) requires comparatively lesser number of the input tokens while formulating the SQL then using an untrained model.

Upon merging all responses from the parallel threads, the trainer engine 608 initiates the serial processing by calling a serial processor 622 with the merged response, received from the parallel processor 612. Further, the serial processor 622 sequentially executes threads upon receiving the merged responses. The serial processor 622 is an application that may run only one thread of code at a time and may execute the next one after the previous thread has finished the execution. Upon receiving the merged response, the serial processor 622 kicks off sequential execution starting with a formula-key value binder 624.

The formula-key value binder 624 replaces variables in SQL formulas translated by the input-to-SQL generators 614. The formula-key value binder 624 is an application that may replace all the variables in the SQL Formula. Upon receiving the merged response, the formula-key value binder 624 creates a final SQL with key values in place and pass it on to an inquiry executor 626.

The inquiry executor 626 executes SQL queries on a user data 628. The user data 628 stores user information for retrieval and processing. The user data 628 belongs to a data store where the user data 628 may be stored in a structured or unstructured or semi-structured or graph or hybrid or any other form or format for an efficient retrieval. Further, the inquiry executor 626 is an application that receives the final SQL query with key values and execute the final SQL query on a data store with the user data 628 to fetch insights and pass it on to a result processor 630.

The result processor 630 transforms insights for output generation. The result processor 630 may correspond to an application that receives the retrieved results and transform the retrieved results to a right format which is acceptable by a result-to-output generator 632. The result-to-output generators 632 produce a final output based on query results. The result-to-output generator 632 is one or more A.I. applications that can use the pre-trained knowledge along with the set of rules 618, metadata, master data and any other configuration data or inputs 620 to generate the final output based on the query results.

Further, an output handler 634 prepares output for transmission to the user. The output handler 634 may be an application that can apply necessary transformations before transmitting the final output back to the user via an output device 636. The output device 636 sends output to users in various formats. The output device 636 may be a device that can receive an output message (or output) in either text, audio or video or mixed form and sends the output to the user. The output device 636 may be a user device, for example, a mobile phone, a computer system, or a laptop etc. The output device 636 may have a digital screen and an audio output device to aid in rendering the output to the system in FIG. 6 (a).

In an example, the parallel processor 612, serial processor 622, and the result processor 630 may include custom algorithms, business logic functions. In addition, the parallel processor 612, serial processor 622, and the result processor 630 may include GPUs or microcontroller(s), such as ARM processors, x86 processors, DSPs or ASICs. Particularly, DSPs are designed for real-time signal processing tasks such as audio, video, and telecommunications and used in speech recognition and audio processing software. ASICs may be custom-designed for specific software tasks, such as A.I. model inference and thus may be used in high-efficiency computing for niche applications.

FIG. 6(b) illustrates a detailed system architecture for dynamic knowledge processing and resource management, in accordance with an embodiment of the present invention. In case, the merged response generated by the parallel processor 612 in FIG. 6(a) indicates that the A.I. system(s) seek external knowledge, the trainer engine 608 may translate the inquiry to a consumable-demand-request, using the plurality of input translator subsystems 130, and send the consumable-demand-request to a consumable requestor 638 via a dynamic knowledge demand request (shown as interconnection A in FIG. 6(a) and FIG. 6(b)).

The consumable requestor 638 is part of the consumable management assistant subsystem 150. The consumable requestor 638 may receive the input, i.e., the consumable-demand-request, from the user engine 610 and transform the consumable-demand-request. The consumable requestor 638 may then send the consumable request to a consumable request handler 640.

The consumable request handler 640 processes and verifies the consumable requests. The consumable request handler 640 may correspond to an application that transforms the consumable request and checks whether a requested consumable associated with the transformed consumable-demand-request is available in the consumable catalog 642 for the user.

The consumable catalog 642 may correspond to a database that inventories consumable resources which are already deployed and are ready to be delivered back to the user as a response to the query, and the consumable catalog 642 comprises consumable resources from at least one of a training and an inference dataset.

In case, the requested consumable associated with the transformed consumable-demand-request is available in the consumable catalog 642, the consumable request handler 640 receives the consumable information from the consumable catalog 642 and pass it back to the user engine 610 to transmit back to the user (shown as interconnection B in FIG. 6(a) and FIG. 6(b)).

However, if the requested consumable is not available in the consumable catalog 642 for the user, then the consumable catalog 642 dynamically triggers a demand request to a demand-supply-value (DSV) engine for the requested consumable. Alternately, the consumable catalog 642 may trigger a consumable demand-supply-value-estimator 644 for the requested consumable. The consumable demand-supply-value-estimator 644 assesses demand supply-value for the consumables based on the transformed consumable-demand-request. The consumable demand-supply-value-estimator 644 is one or more A.I. applications that encompasses the demand-supply-value (DSV) engine and work together with the consumable catalog 642 to generate demand-supply-value for the requested consumable.

Upon assessing the demand for the requested consumable, the consumable demand-supply-value-estimator 644 sends it to a consumable demand publisher 646. The consumable demand publisher 646 disseminates demand information and is one or more applications along with a dashboard that publishes the consumable demand to partnered consumable demand viewers 648.

The consumable demand viewers 648 develop consumables based on the demand information. The consumable demand viewers 648 is one or more applications or partner users who browses a consumable demand dashboard and so they can develop the requested consumable for the users.

Further, the consumable demand viewers 648 is communicatively connected to a consumable provider 650 which produces consumables for users. The consumable provider 650 is either an external service provider which supplies real time values of assets pertaining to the query, an entity pertaining to the query, or a user in the consumable management assistant subsystem 150 and releases to a consumable integrator 652 which manages deployment of consumables. The consumable integrator 652 is one or more applications that receives the consumable from the partner applications or users and sends it to a consumable publisher 654. The consumable publisher 654 prepares and publishes the consumables which are available for the users. The consumable publisher 654 is one or more applications that prepares the consumable for deployment and publishes to the consumable catalog 642 for user consumption.

Thus, the consumable provider 650 and the consumable integrator 652 enables the A.I. assistants to access external resources beyond their pre-trained skill sets, enhancing their capability to fulfil diverse user requests. The integration is facilitated by the demand-supply-value (DSV) engine which dynamically matches user demands with available consumables, fostering a collaborative ecosystem of service providers and consumers.

Further, as a part of the reward distribution subsystem 160, a consumable reviewer 656 evaluates the available consumables with reference to the consumable-demand-request and provides feedback in the form of reviews, rates, ranks, or scores. The consumable reviewer 656 may correspond to one or more applications or end-users who may have used the consumable(s) and provided reviews, rates, ranks, or scores and submitted the same to a consumable review handler 658. The consumable review handler 658 processes the feedback received from the consumable reviewer 656. The consumable review handler 658 is an application that receives the review for each consumable and transmits the same to a consumable reward estimator 660.

The consumable reward estimator 660 calculates rewards based on the feedback. The consumable reward estimator 660 is one or more A.I. applications that receive the consumable review and generate the deserving reward for both the consumable user and consumable provider 650 based on collective reviews, ratings, ranks, and scores. The consumable reward estimator 660 passes the reviews, ratings, ranks, and scores to a consumable feedback loop 662. If the reward is determined to be paid, then the consumable reward estimator 660 also sends the reward details to a consumable reward payer 664. The consumable feedback loop 662 may relays feedback to the consumable providers 650. The consumable reward payer 664 distributes rewards to the consumable providers 650 and users. The consumable reward payer 664 is an application that credit/debits the rewards based on the contractual obligations made between the business and the consumable provider 650. The consumable reward payer 664 also credits the rewards to the user(s) based on their contractual obligations made with the business.

In addition, the consumable feedback loop 662 and the reward distribution subsystem 160 allows the context driven platform to detect scenarios where the rendered output contains information not present in original user queries.

In an example, the parallel processor 612, serial processor 622, and a result processor 630 may include custom algorithms, business logic functions, and GPUs or microcontroller(s), such as ARM processors, x86 processors, DSPs or ASICs.

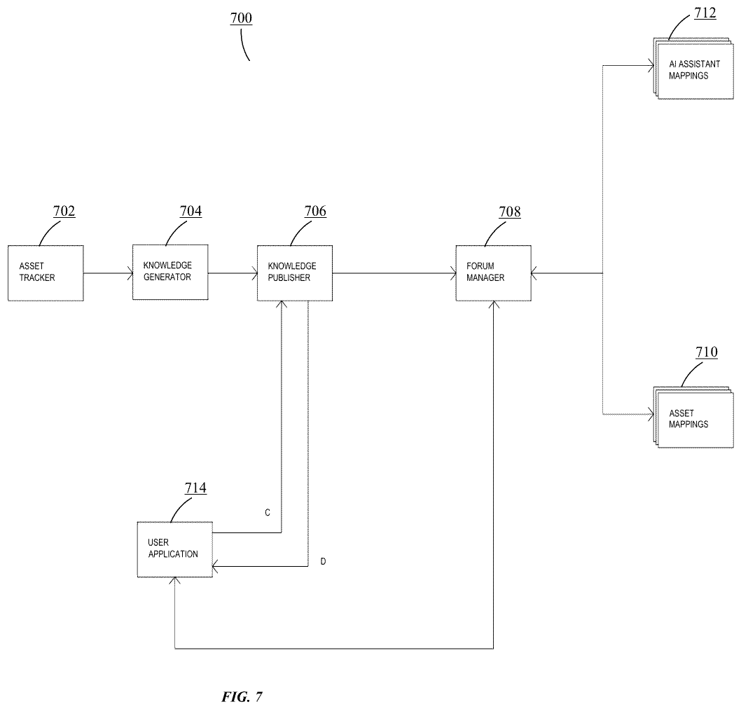

FIG. 7 illustrates a detailed system architecture for driving a context specific forum in an A.I. virtual assistant driven marketplace, in accordance with an embodiment of the present invention. The detailed system architecture in FIG. 7 depicts backend of an application for driving the context specific forum in an A.I. virtual assistant driven marketplace. The context specific forum is utilized when a user application 714 runs using the A.I. virtual assistant. The context specific forum may have an asset tracker 702 which tracks assets real time value of assets which are in high demand. The assessment of high demand may be derived from the demand-supply-value-estimator 644 of FIG. 6 (b). The real time values of the assets are determined either by the A.I. system or human or augmented inputs (utilizing both the human inputs and A.I. inputs). To meet the requirements of the present invention, the invention may include one or more asset tracker(s) 702.

In an embodiment of the present invention, the real time values of the assets may be continuously updated from a source database. Moreover, an A.I. agent could be published by the context specific forum which may remember search history of the user and then update algorithm. Thus, whenever a similar query is raised by any user in the forum then the published A.I. agent could address the queries.

Further, the asset tracker 702 may include a datastore (not shown in FIG. 7) to store and manage all available assets of interest from a plurality of context driven forums. In addition, the asset tracker 702 may include a data processor (not shown in FIG. 7) to retrieve real time data values of assets from internal and external service providers, using the plurality of asset trackers. The real time knowledge is stored in one or more formats, where the one or more formats include at least one of text, image, audio, and video, etc.

Also, the data processor updates the datastore with the retrieved data values of assets and transfer past data to a repository. Further, the asset tracker 702 may be connected to a plurality of knowledge or insight generators 704 which reads the retrieved data values of assets and generate processed data. Further, the asset tracker 702 may be connected to a plurality of insight publishers or knowledge publisher 706 which reads the processed data and based on the processed data, publish progress of values of assets of interest to all user devices (as indicated by interconnections C and D in FIG. 7) which are currently being watched or monitored by forum users. By streamlining the data retrieval processes using the plurality of insight generators 704, resource utilization may be optimized and operational costs may be minimized. Regardless of a timeframe of the requested data, whether from yesterday or five years ago, the data retrieval process remains efficient, without incurring high memory and cost. The efficiency is achieved through a systematic division of tasks among the plurality of virtual assistant subsystems, thereby ensuring consistent performance irrespective of the query's complexity or historical context.

The plurality of insight publishers 706 may further be connected to a forum manager 708 which includes a plurality of both asset mappings 710 and A.I. assistant mappings 712. The forum manager 708 creates, reads, updates, or delete all data related to the context specific forum and is dynamically connected to the user application 714. Herein, all forum related data is provided by client applications on user devices via a secure application programming interface. Further, the forum manager 708 manages mapping of assets associated with each forum of the plurality of forums, mapping of A.I. virtual assistants assigned to each forum of the plurality of forums, and history of questions and answers exchanged on the plurality of forums. Each of the asset mappings 710 represent assignment of one or more assets in each forum of the plurality of forums and the each of A.I. assistant mappings 712 represent assignment of one or A.I. virtual assistants to each forum of the plurality of forums. It is to be noted that terms ‘A.I. virtual assistant’ and ‘A.I. assistant’ have been used interchangeably throughout the present disclosure.

The backend represented by FIG. 7 is connected to a custom-built user application which is an end user application 714 that represents a web or mobile application.

In an example, the formula-key-value binder 624, inquiry executor 626, review handler 658, consumable reward payer 664, consumable reviewer 656, consumable requestor 638, consumable request handler 640, the consumable provider 650, and consumable reward estimator 660 may include custom algorithms, business logic functions, executed by GPUs or microcontroller(s), such as ARM processors, x86 processors, DSPs or ASICs.

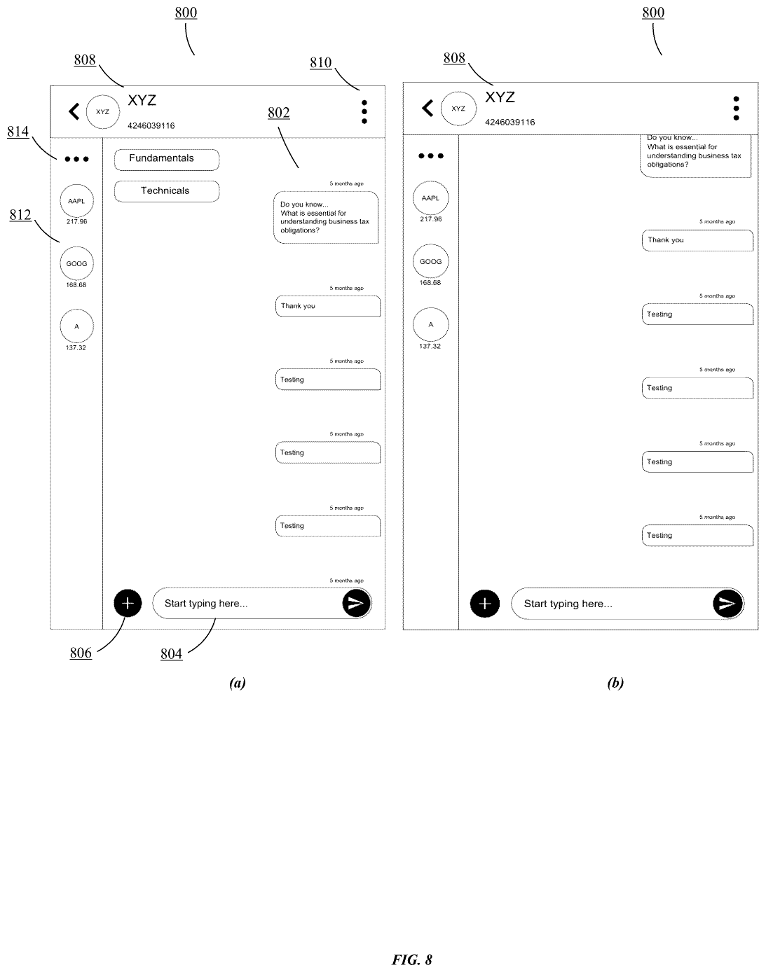

FIG. 8(a) illustrates an exemplary graphical user interface (GUI) 800 of an application for driving a context specific forum in an A.I. virtual assistant driven marketplace, in accordance with an embodiment of the present invention. FIG. 8 (a) depicts frontend of the application for driving the context specific forum in the A.I. virtual assistant driven marketplace. The GUI shows a dashboard which represents a web or mobile application and is custom-built for an end user. The dashboard is designed for controlling and interacting with the A.I. virtual assistant which the user may either access through the web browser on a computer device or may download from an application store or and install on the user device. The GUI (hereinafter referred to as the ‘interface’) 800 may be displayed on a user device which may be a touchscreen device, for example, a smartphone, tablet, or other computing device.

The interface 800 may include a central interaction area 802 that occupies the majority of a display screen of the user device. The central interaction area 802 may serve as a primary conversational interface, where the A.I. virtual assistant visually presents responses to user queries, instructions, or input(s) and may provide updates related to pending tasks, reminders, or incoming system prompts.

The interaction area may be complemented by an input field 804 located at a lower part of the display screen. The users may enter text-based queries or commands into the input field 804, which triggers the A.I. virtual assistant to process the information.

To the left of the input field 804, a plus icon 806 may be displayed. The plus icon 806 may provide plurality of options to end users. In an example, the plus icon 806 may enable upload or attachment of any files. In another example, the plus icon 806 may enable starting a new conversation with the A.I. virtual assistant. In another example, the plus icon 806 may enable users to activate voice-based input functionality, allowing for hands-free operation and voice commands. In another example, the plus icon 806 may include a settings icon for enabling the access to customization options, such as language settings, speech tone or voice command or video input, or interaction preferences.

Above the central interaction area 802, a user identity region 808 may be displayed which may indicate a name of the user, avatar picture, and a device ID. The avatar picture in the user identity region 808 may include a customizable avatar or an image of the user. Beside the avatar, a user' name or profile name may be prominently displayed, which may add a personalized touch to the user experience. In addition, the top area of the display screen, at the right, may display a three-dots icon 810. The three-dots icon 810 may open a drop-down menu to select from a list of options. In an example, the list of options may include language settings, screen sizes and resolutions adjustment, help, login, usage plans, feedback, mode selection, and more options etc.

In an implementation, the mode selection may include a plurality of modes, for example, a mode to enable the A.I. virtual assistant (hereinafter referred to as enable mode) or to disable the A.I. virtual assistant (hereinafter referred to as disable mode). While starting a new interaction thread or during an existing interaction, one of the enable or disable modes may be selected by the users. In the enable mode, user-to-user and user to the A.I. virtual assistant communication may be availed. In the disabled mode, only user-to-user communication may be availed.

When the enable mode is selected either at the beginning of the group interaction or during the group interaction on the context specific forum, then every user who is participant of the group interaction may get a request to provide a consent for the enable mode. Upon getting approval from all the participants, the group interaction may be continued.

An example of the user-to-user and the user to the A.I. virtual assistant communication interaction by availing the enable mode is displayed in FIG. 8(a).

In a preferred embodiment of the present invention, the interface 800 may display real time value of financial statistics below the user identity region 808 as a horizontal strip and the same may get updated lively.

In an embodiment of the present invention, the interface 800 may display advertisement icons relevant to user queries on a vacant space at the central interaction area 802. The user may provide consent to display or turn off the display of the advertisement icons.

On the left side of the central interaction area 802, an assistant profile area 812 may be depicted. The assistant profile area 812 may display a plurality of transformer models or real time value of assets. The plurality of transformer models or real time value of assets may be shown with their names, identification codes, customizable avatars, or graphical representations. In addition, the top area of the display screen, at the left, may display a three-dots icon 814. The three-dots icon 814 may open a drop-down menu to select from a list of options. In an example, the list of options may include more assets with real-time value to select from, real-time feedback of a selected A.I. virtual assistant, processing status, connectivity updates, list of other A.I. virtual assistant, and more options etc.

In an example, the interface 800 may incorporate a series of shortcut buttons aligned horizontally below the central interaction area 802 to enhance usability. The shortcut buttons may represent common actions or commands, such as processing status, starting specific predefined workflows, and accessing recent interactions, etc. Each shortcut button may be visually represented with identifiable icons and labels.

FIG. 8 (b) illustrates an exemplary graphical user interface (GUI) 800 of an application for driving a context specific forum in an A.I. virtual assistant driven marketplace, in accordance with an embodiment of the present invention. FIG. 8 (b) depicts frontend of the application for driving the context specific forum in the A.I. virtual assistant driven marketplace. Further, the reference numerals illustrated in FIG. 8(a) are also applicable mutatis mutandis to the segments of FIG. 8 (b) and thus are not represented again in FIG. 8 (b) to avoid repetition.

An example of the interaction by availing the disable mode is displayed in FIG. 8(b). The interface 800 represents results upon entering the query into the input field 804 and the user-to-user interaction.

In an example, in central interaction area 802, below the results of the query, a plurality of feedback and action icons may be displayed. The plurality of feedback and action icons may include a like gesture, a dislike gesture, a review symbol, rating stars, and a copy symbol, etc. The user upon receiving the results may provide feedback to the A.I. assistant through the plurality of feedback and action icons.

In another example, the A.I. virtual assistant may give suggestions to the user for better clarity by providing more information or prompt to ask more questions.

The interface may be designed using the coding languages such as, javascript, python, and SQL, etc. Further, various open-source frameworks such as Note JS, flutter, react native, Xamarin, iconic framework, codova, asp.net, and nativescript, etc. may be employed to create the frontend. The disclosed interface supports multimodal interaction by enabling users to toggle between text, voice, and video input methods seamlessly. Additionally, the interface adapts to different screen sizes and resolutions, thereby ensuring optimal rendering of the output across various user devices.

Therefore, the disclosed invention presents a new way of orchestrating the A.I. assistants with the division of responsibility combined with the power of DSV engine. The virtual personal assistants can thus scale their knowledge and serviceability with a minimal reprogramming and retraining efforts and cost.

In essence, the disclosed invention revolutionizes the landscape of A.I. powered virtual assistants by offering a scalable, privacy conscious, and resource-efficient solution that enhances user experiences and facilitates seamless interactions between humans and machines.

By combining the capabilities of A.I. powered knowledge publishing, advanced dashboard functionalities, and transparent collaboration facilitated by forum management systems, the disclosed invention represents a pioneering solution for democratizing knowledge sharing and fostering informed decision-making in a marketplace environment.

When discussing the invention, it is important to recognize that various techniques and steps are disclosed, each offering distinct advantages and capable of being employed independently or in combination with one another. Therefore, this description avoids redundant enumeration of all possible combinations of individual steps to maintain clarity. However, it should be noted that such combinations are fully encompassed within the scope of the invention and the accompanying claims. Consequently, the specification and claims should be interpreted with the understanding that these combinations are permissible and fall within the ambit of the invention.

In a case that no conflict occurs, the embodiments in the present disclosure and the features in the embodiments may be mutually combined. The foregoing descriptions are merely specific implementations of the present disclosure, but are not intended to limit the protection scope of the present disclosure. Any variation or replacement readily figured out by a person skilled in the art within the technical scope disclosed in the present disclosure shall fall within the protection scope of the present disclosure. Therefore, the protection scope of the present disclosure shall be subject to the protection scope of the claims.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated.

The invention claimed is:

1. A system for dynamic knowledge processing and resource management, the system comprising:
an input subsystem to receive an input;
a plurality of virtual assistant subsystems communicatively coupled to the input subsystem, wherein a plurality of virtual assistant subsystems comprises:
a plurality of input translator subsystems to translate the input into a query; and
a consumable management assistant subsystem which includes a consumable catalog and a consumable provider,
a virtual assistant subsystem, from the plurality of virtual assistant subsystems, is to:
upon checking that a response to the query requires external knowledge, send the query to the consumable management assistant subsystem, wherein the consumable management assistant is to:
detect whether the response to the query is available in the consumable catalog; and
based on the query and available consumables in the consumable catalog, render the response to the query by the consumable provider; and
generate an output from the rendered response.

2. The system of claim 1, wherein the input subsystem is configured to:
route the input to one or more virtual assistant subsystems of the plurality of virtual assistant subsystems based on context and intent of a user.

3. The system of claim 1, wherein the input subsystem comprises:
an input handler to receive the input from a user in one or more formats of media provided by an electronic device and apply transformations to the input so as to make input data favorable for downstream transmission, and
wherein the at least one of the formats comprise text, audio, and video, and wherein the system comprises an output handler, communicatively coupled to the plurality of virtual assistant subsystems, to transform the rendered response and deliver the output to a user via output devices.

4. The system of claim 1, wherein each virtual assistant subsystem of the plurality of the virtual assistant subsystems comprises a user engine connected to a parallel processor and a serial processor, wherein the user engine is configured to:
infer the input received from the input subsystem;
trigger parallel execution of multiple threads based on the inferred input to generate a merged response, by the parallel processor; and
sequentially process, by the serial processor, the merged response received from the parallel processor.

5. The system of claim 1, wherein an input translator subsystem of the plurality of input translator subsystems is to convert the query in a SQL query with appropriate variables pertaining to the input and generate key values for variables.

6. The system of claim 1, wherein upon checking that the response to the query requires external knowledge, the virtual assistant subsystem comprising a user engine is to:
translate, by the user engine, the query into a consumable-demand-request; and
send the consumable-demand-request to a consumable requestor, which is an entity in the consumable management assistant subsystem, wherein the consumable requestor is to:
transform the consumable-demand-request; and
check whether a requested consumable associated with the transformed consumable-demand-request is available in the consumable catalog.

7. The system of claim 6, wherein based on the transformed consumable-demand-request and available consumables in the consumable catalog, the consumable catalog is to dynamically trigger a demand request to a demand-supply-value (DSV) engine for the requested consumable.

8. The system of claim 6, wherein the system comprises:
a consumable demand publisher to publish the consumable-demand-request;
a consumable demand viewer to develop a requested consumable based on the published consumable-demand-request, and
a reward distribution subsystem, to estimate and distribute rewards to a consumable user and consumable provider, based on evaluation of the response rendered by the consumable provider.

9. The system of claim 1, wherein the consumable management assistant subsystem is communicatively connected to a data management subsystem comprising at least:
i) a rules repository;
ii) a configuration data repository; and
iii) a user data store.

10. The system of claim 1, wherein the consumable catalog inventories consumable resources which are already deployed and are ready to be delivered back to a user as a response to the query, and wherein the consumable catalog comprises consumable resources from at least one of a training and an inference dataset.

11. The system of claim 1, wherein the consumable provider is one of an external service provider which supplies real time values of assets pertaining to the query, an entity, and a user in the consumable management assistant subsystem.

12. A system for operating a context specific forum in an A.I. virtual assistant driven marketplace, the system comprising:
a datastore to store and manage all available assets of interest from a plurality of forums;
a data processor to:
retrieve real time data values of assets from internal and external service providers, using the plurality of asset trackers; and
update the datastore with the retrieved data values of assets and transfer past data to a repository;
a plurality of insight generators to read the retrieved data values of assets and generate processed data;
a plurality of insight publishers to:
read the processed data; and
based on the processed data, publish progress of values of assets of interest to all user devices which are currently being watched or monitored by forum users; and
a forum manager including a plurality of both asset mappings and A.I. mappings to:
create, read, update, or delete all data related to the context specific forum; and
manage mapping of assets associated with each forum of the plurality of forums, mapping of A.I. virtual assistants assigned to each forum of the plurality of forums, and history of questions and answers exchanged on the plurality of forums, wherein
each of the asset mappings represent assignment of one or more assets in each forum of the plurality of forums and the each of A.I. virtual assistant mappings represent assignment of one or A.I. virtual assistants to each forum of the plurality of forums.

13. The system of claim 12, wherein the real time knowledge is stored in one or more formats, wherein the one or more formats include at least one of text, image, audio, and video, etc.

14. The system of claim 12, wherein all forum related data is provided by client applications on devices via a secure application programming interface.

15. A method for dynamic knowledge processing and resource management, the method comprising:
implemented by an input subsystem, a plurality of the virtual assistants communicatively coupled to the input subsystem, a plurality of input translator subsystems, and a consumable management assistant subsystem, wherein the plurality of input translator subsystems and the consumable management assistant subsystem are communicatively coupled to the plurality of the virtual assistants:
receiving an input, by the input subsystem;
translating the input into a query, by an input translator subsystem of the plurality of input translator subsystems;
upon checking, by a virtual subsystem of the plurality of virtual subsystems, that a response to the query requires external knowledge, sending the query to the consumable management assistant subsystem which includes a consumable catalog and a consumable provider;
detecting whether the response to the query is available in the consumable catalog;
based on the query and available consumables in the consumable catalog, rendering the response to the query by a consumable provider; and
generating an output from the rendered response.

16. The method of claim 15, wherein the virtual assistant from the plurality of the virtual assistants comprises one or more user engines connected to a parallel processor and a serial processor, wherein the method comprises:
detecting whether the input is for training or inference;
upon detecting an inference input, generating a request based on the inference input;
triggering parallel execution of multiple threads based on the inferred input to generate a merged response, by the parallel processor; and
sequentially processing, by the serial processor, the merged response received from the parallel processor.

17. The method of claim 15, wherein upon checking that the response to the query requires external knowledge, the method comprises:
translating the query into a consumable-demand-request; and
sending the consumable-demand-request to a consumable requestor, which is an entity in the consumable integration subsystem, wherein the consumable requestor is for:
transforming the consumable-demand-request; and
checking whether a requested consumable is available in a consumable catalog.

18. The method of claim 17, wherein the method comprises:
dynamically triggering a demand request for the requested consumable, to a demand supply value (DSV) engine, based on the transformed consumable-demand-request and available consumables in the consumable catalog, and
publishing an A.I. agent as per the consumable-demand-request.

19. A method for driving a context specific A.I. virtual assistant platform having an asset tracker, an insight generator, and an insight publisher, the method comprising:
receiving and storing real time values of assets, determined by at least one of an A.I. virtual assistant, human, and augmented input of the A.I. virtual assistant and the human;
generating, by an insight generator, processed data by using the real time values of assets from the asset tracker;
availing the processed data as insights in one or more consumable formats for client applications; and
publishing the insight, by the insight publisher, on a user device.

20. The method of claim 19, wherein the method comprises publishing the insight on the user device by either pushing down on the user device on-demand via pull requests or automatically by push requests in real time.
